(19) United States
(12) Patent Application Publication
(10) Pub. No.: US 2024/0430243 A1
(43) Pub. Date: Dec. 26, 2024

(54) DATA MANAGEMENT DEVICE, KEY MANAGEMENT DEVICE, DATA MANAGEMENT METHOD, AND KEY MANAGEMENT METHOD

(71) Applicant: NEC Corporation, Tokyo (JP)

(72) Inventors: Yoshitomo WARASHINA, Tokyo (JP); Toshiyuki ISSHIKI, Tokyo (JP); Kengo MORI, Tokyo (JP); Haruna FUKUDA, Tokyo (JP); Hidenobu OGURI, Tokyo (JP)

(73) Assignee: NEC Corporation, Tokyo (JP)

(21) Appl. No.: 18/736,799

(22) Filed: Jun. 7, 2024

(30) Foreign Application Priority Data
Jun. 26, 2023 (JP) 2023-104271

(51) Int. Cl. H04L 9/40

(52) U.S. Cl. CPC H04L 63/062; H04L 63/0823

(57) ABSTRACT

A data management device includes a generation unit, a registration unit, an output unit, an acquisition unit, a determination unit, and a key output unit. The generation unit generates a first secret key that is restorable by a predetermined number of distributed keys. The registration unit registers data encrypted by using the first secret key in a database of a data storage device. The output unit outputs at least one distributed key among the distributed keys used to restore the first secret key to a key management device. The determination unit determines whether to agree to permission of a use request for data in intention expression on agreement or disagreement performed. When it is determined to agree to the permission of the use request for the data, the key output unit outputs, to the key management device, a key necessary for restoring the first secret key.

This application is based upon and claims the benefit of priority from Japanese Patent Application No. 2023-104271, filed on Jun. 26, 2023, the disclosure of which is incorporated herein in its entirety by reference.

### TECHNICAL FIELD

The present disclosure relates to a data management device and the like.

### BACKGROUND ART

Data transactions may be performed via a database arranged in a storage device on the network. For example, when a data management device of PTL 1 (WO 2016/158721 A1) is requested by a user to decrypt encrypted data, the data management device generates a decryption key by using information for decryption acquired from another user. Then, the data management device decrypts the data by using the generated decryption key.

### SUMMARY

An object of the present disclosure is to provide a data management device and the like capable of suppressing data leakage.

A data management device according to an aspect of the present disclosure includes: a generation unit that generates a first secret key that is restorable by a predetermined number of distributed keys; a registration unit that registers data encrypted by using the first secret key in a database of a data storage device; an output unit that outputs at least one distributed key among distributed keys used to restore the secret key to a key management device that stores the distributed key and restores the first secret key; an acquisition unit that acquires a use request for the data registered in the database; a determination unit that determines whether to agree to permission of the use request for the data in intention expression on agreement or disagreement performed by each member of an organization that permits the use request for the data based on agreement of a plurality of members; and a key output unit that outputs, to the key management device, a key necessary for restoring the first secret key relevant to the requested data when it is determined to agree to the permission of the use request for the data.

A key management device according to an aspect of the present disclosure includes: a distributed key acquisition unit that acquires at least one distributed key among distributed keys of a first secret key that is used to encrypt data registered in a database and is restorable with a predetermined number of distributed keys; a restoration key acquisition unit that acquires a key necessary for restoring the first secret key from a data management device that has determined to agree to permission of the use request for the data in intention expression on agreement or disagreement performed by each member of an organization that permits the use request for the data based on agreement of a plurality of members; a restoration unit that restores the secret key based on the distributed key and the key necessary for restoring the first secret key; and a secret key output unit that outputs the restored secret key to a user device used by a user who has made the use request for the data.

A data management method according to an aspect of the present disclosure includes: generating a first secret key that is restorable by a predetermined number of distributed keys; registering data encrypted by using the first secret key in a database of a data storage device; outputting at least one distributed key among distributed keys used to restore the secret key to a key management device that stores the distributed key and restores the first secret key; acquiring a use request for the data registered in the database; determining whether to agree to permission of the use request for the data in intention expression on agreement or disagreement performed by each member of an organization that permits the use request for the data based on agreement of a plurality of members; and outputting, to the key management device, a key necessary for restoring the first secret key relevant to the requested data when it is determined to agree to the permission of the use request for the data.

A key management method according to an aspect of the present disclosure includes: acquiring at least one distributed key among distributed keys of a first secret key that is used to encrypt data registered in a database and is restorable with a predetermined number of distributed keys; acquiring a key necessary for restoring the first secret key from a data management device that has determined to agree to permission of the use request for the data in intention expression on agreement or disagreement performed by each member of an organization that permits the use request for the data based on agreement of a plurality of members; restoring the first secret key based on the distributed key and the key necessary for restoring the first secret key; and outputting the restored first secret key to a user device used by a user who has made the use request for the data.

A recording medium according to an aspect of the present disclosure non-transitorily records a data management program for causing a computer to execute: a process of generating a first secret key that is restorable by a predetermined number of distributed keys; a process of registering data encrypted by using the first secret key in a database of a data storage device; a process of outputting at least one distributed key among distributed keys used to restore the first secret key to a key management device that stores the distributed key and restores the first secret key; a process of acquiring a use request for the data registered in the database; a process of determining whether to agree to permission of the use request for the data in intention expression on agreement or disagreement performed by each member of an organization that permits the use request for the data based on agreement of a plurality of members; and a process of outputting, to the key management device, a key necessary for restoring the secret key relevant to the requested data when it is determined to agree to the permission of the use request for the data.

A recording medium according to an aspect of the present disclosure non-transitorily records a key management program for causing a computer to execute: a process of acquiring at least one distributed key among distributed keys of a first secret key that is used to encrypt data registered in a database and is restorable with a predetermined number of distributed keys; a process of acquiring a key necessary for restoring the first secret key from a data management device that has determined to agree to permission of the use request for the data in intention expression on agreement or disagreement performed by each member of an organization that permits the use request for the data based on agreement of a plurality of members; a process of restoring the first secret key based on the distributed key and the key necessary for restoring the first secret key; and a process of outputting the restored first secret key to a user device used by a user who has made the use request for the data.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a data providing system according to the present disclosure.

FIG. 2 is a diagram schematically illustrating an example of processing performed in the data providing system according to the present disclosure.

FIG. 3 is a diagram illustrating an example of a configuration of a data management device according to the present disclosure.

FIG. 4 is a diagram illustrating an example of a configuration of a key management device according to the present disclosure.

FIG. 5 is a diagram illustrating an example of an operation flow of the data management device in the present disclosure.

FIG. 6 is a diagram illustrating an example of an operation flow of the data management device in the present disclosure.

FIG. 7 is a diagram illustrating an example of an operation flow of the key management device in the present disclosure.

FIG. 8 is a diagram illustrating an example of a hardware configuration of the data management device according to the present disclosure.

### EXAMPLE EMBODIMENT

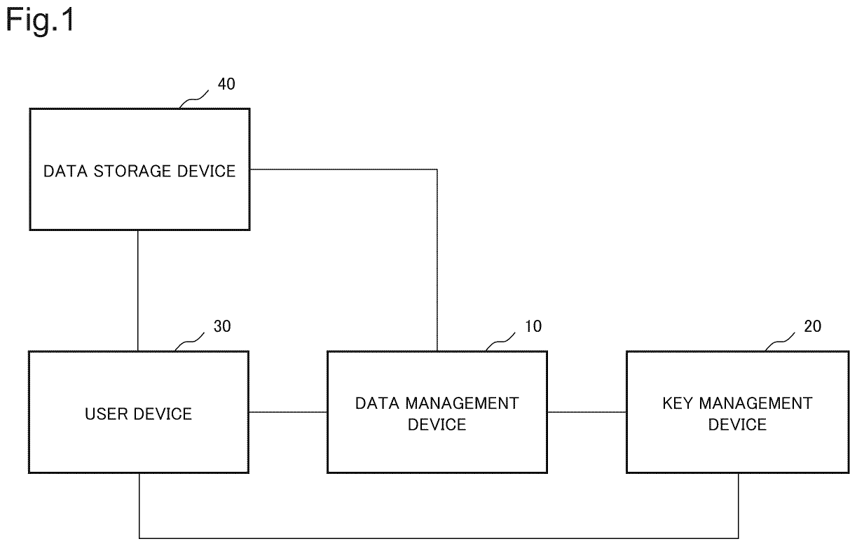

An example embodiment of the present disclosure will be described in detail with reference to the drawings. FIG. 1 is a diagram illustrating an example of a configuration of a data providing system. The data providing system includes, for example, a data management device 10, a key management device 20, a user device 30, and a data storage device 40. The data providing system includes a plurality of data management devices 10. In addition, a plurality of key management devices 20, a plurality of user devices 30, and a plurality of data storage devices 40 may be provided. In addition, the data storage device 40 may be a data space. The number of the data management devices 10, the number of the key management devices 20, the number of the user devices 30, and the number of the data storage devices 40 can be appropriately set. In addition, the data management device 10, the key management device 20, the user device 30, and the data storage device 40 are connected to each other via a network, for example. In addition, the plurality of data management devices 10 are connected to each other via a network, for example.

The data providing system is, for example, a system that provides data registered in a database in response to a use request from a user. The user is, for example, an entity who receives, from a data provider, permission to use data and uses data registered in the data providing system. In addition, the data provider is, for example, an entity having an authority to determine whether to permit a use request for the data registered in the database. That is, the data provider is, for example, an entity having a right regarding the data registered in the database. The data provider may be, for example, an entity that has registered the data in the database.

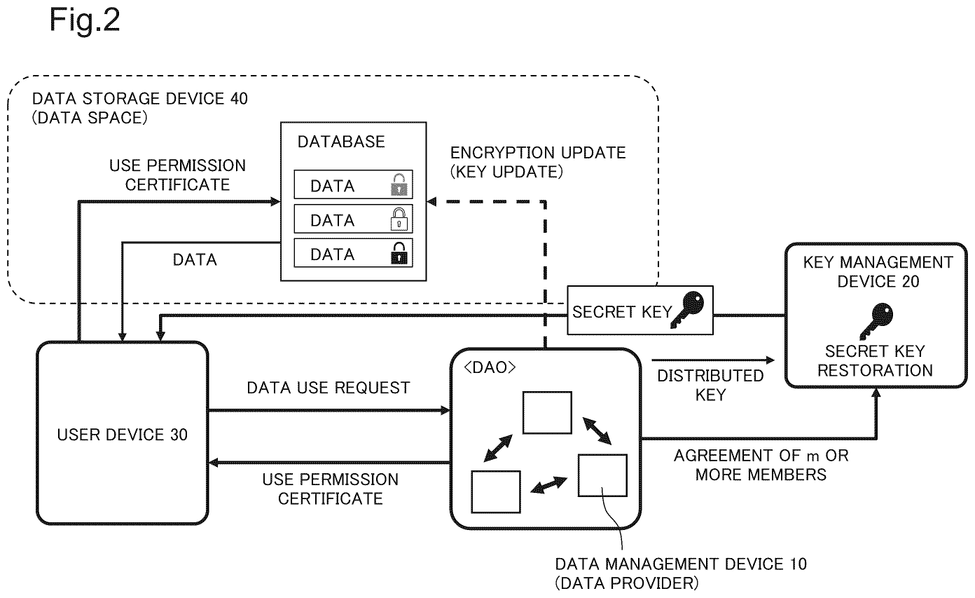

FIG. 2 is a diagram schematically illustrating an example of processing performed in the data providing system.

The data registered in the database of the data storage device 40 is encrypted, for example, by the data provider using a secret key. For example, the data user makes a use request for the data registered in the database to the data provider. The data user can use the data when the data provider has determined to permit the use request for the data. For example, the data user can acquire a secret key for decrypting the encrypted data when it is determined to permit the use request for the data. Then, the data user uses the data by decrypting, with the secret key, the encrypted data acquired from the database.

The permission to use the data is made, for example, through determination-making in a decentralized autonomous organization. The decentralized autonomous organization is also referred to as a DAO. The decentralized autonomous organization is, for example, an organization to which the data provider belongs as a member. The permission of the use request for the data registered in the database is determined, for example, when a predetermined number or more of members have agreed to the provision of the data requested by the user. For example, in a case where a use request for data is received, each member of the decentralized autonomous organization expresses an intention to agree to permission of the use request for data. Then, when a predetermined number or more of members express intentions of agreement, it is determined to permit the use request for data. The predetermined number of members is set as, for example, a majority of the total number of members. The predetermined number of members is not limited to the majority of the total number of members. The predetermined number is set by, for example, an operator of the decentralized autonomous organization. The predetermined number of members may be set by determination-making in the decentralized autonomous organization. In addition, an organization that permits the use of data is not limited to the decentralized autonomous organization. For example, the permission of the use request for data may be performed by a server, which manages the organization, confirming whether each member of the organization agrees to the permission.

In addition, in the example of FIG. 2, each of the data management devices 10 is a device used by each member of the decentralized autonomous organization. Each of the members of the decentralized autonomous organization determines whether to agree to the permission of the use request for data by operating the data management device 10 used by the member, for example. That is, in the decentralized autonomous organization, it is determined to permit the use request for the data when a predetermined number of data management devices 10 have determined to agree to the permission of the use request for the data.

In the data providing system, the secret key used to encrypt the data is divided and stored as distributed keys, for example. For example, the distributed keys are generated in such a way that the secret key can be restored in a case where a predetermined number or more of distributed keys are used. The predetermined number is set based on, for example, the number of members necessary for the permission of data use in the decentralized autonomous organization.

The distributed keys of the secret key used to encrypt the data are stored separately for the data management device 10 and the key management device 20, for example. For example, some of the distributed keys are stored in the key management device 20 that restores the secret key in a state where the secret key cannot be restored. The state where the secret key cannot be restored refers to, for example, a state where the secret key cannot be restored only with the distributed key stored in the key management device 20. The state where the secret key cannot be restored only with the distributed key stored in the key management device 20 is, for example, a state where it is necessary to acquire the distributed keys from the data management device 10 in addition to the distributed key stored in the key management device 20 in order to restore the secret key. For example, the key management device 20 stores, for example, one distributed key among a plurality of distributed keys necessary for restoring the secret key. For example, it is assumed that the data use is permitted in a case where m or more (m is a positive integer) members among the members of the decentralized autonomous organization have agreed. In this case, the number of the distributed keys required for restoring the secret key is, for example, m+1 (m is a positive integer). The key management device 20 can restore the secret key, for example, when m distributed keys are acquired from m data management devices 10.

The state where the secret key cannot be restored only with the distributed key stored in the key management device 20 may be a state where the stored distributed key is encrypted by using a secret key for the distributed key. The secret key for the distributed key is a secret key that encrypts the distributed key. In addition, the secret key used to encrypt data is also referred to as a first secret key, and the secret key for the distributed key is also referred to as a second secret key.

In a case where the stored distributed key is encrypted by using the secret key for the distributed key, for example, it is assumed that the number of members in the decentralized autonomous organization is n (n is a positive integer). In addition, it is assumed that the data use is permitted in a case where m or more members among the members of the decentralized autonomous organization have agreed. Then, it is assumed that n distributed keys are generated in such a way that the secret key can be restored by using m or more distributed keys among the n distributed keys. In this case, for example, the n distributed keys are stored in the key management device 20 in an encrypted state by using the secret keys for the distributed keys relevant to respective distributed keys. The state where the stored distributed key is encrypted is a state where the secret key used to encrypt the data cannot be restored unless the secret key for the distributed key is acquired. In addition, in this case, the secret keys for the n distributed keys are allocated to the members of the decentralized autonomous organization one by one. Then, in a case where the member of the decentralized autonomous organization permits the data use, for example, the secret key for the distributed key is output to the key management device 20 from the data management device 10 used by the member who has permitted the data use. At this time, when m or more members permit the data use, m or more distributed keys can be decrypted, so that the secret key used for encryption can be restored.

As described above, the distributed key for restoring the secret key used to encrypt data is stored in the data management device 10 and the key management device 20 in a state where the secret key cannot be restored only with the distributed key stored in a single device. Therefore, for example, the member of the decentralized autonomous organization using each data management device 10 and the administrator of the key management device 20 cannot obtain the secret key used to encrypt data. In addition, since the data storage device 40 also does not possess the secret key, the administrator of the data storage device 40 cannot obtain the secret key. Therefore, the encrypted data cannot be decrypted by a user other than the user who is permitted to use the data and is provided with the secret key. In addition, for example, when the number of times of data use exceeds a predetermined number of times, the data of the database is encrypted again using a regenerated secret key. Therefore, when the number of times of data use exceeds the predetermined number, the user who is permitted to use the data cannot decrypt the data encrypted using the regenerated secret key.

In addition, the data providing system can be used for, for example, information provision in a human resource matching service, sales of survey data, sales of music data, sales of image data, sales of a game, or sales of data for a game. The data provided in the data providing system is not limited to the above.

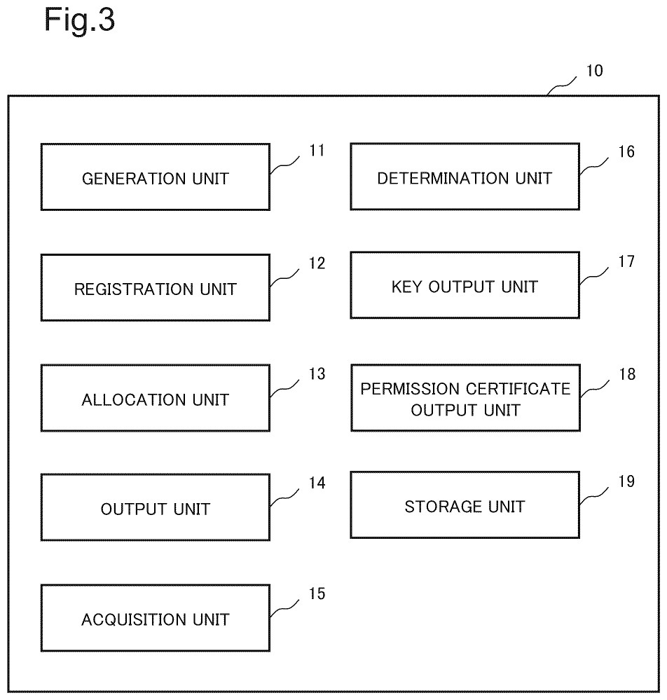

Here, a specific example of the configuration of the data management device 10 will be described. FIG. 3 is a diagram illustrating an example of a configuration of the data management device 10. The data management device 10 includes a generation unit 11, a registration unit 12, an output unit 14, an acquisition unit 15, a determination unit 16, and a key output unit 17 as a basic configuration. In addition, the data management device 10 includes, for example, an allocation unit 13, a permission certificate output unit 18, and a storage unit 19.

The generation unit 11 generates a secret key that can be restored by a predetermined number of distributed keys. Here, the secret key that can be restored by a predetermined number of distributed keys corresponds to the first secret key. The predetermined number is set based on the number of members necessary for determining to permit the use request for data. For example, it is assumed that in the decentralized autonomous organization, permission of the use request for data is determined in a case where m or more members agree to the permission of the use request for data (m is a positive integer). In addition, it is assumed that one distributed key among the distributed keys necessary for restoring the secret key is stored in the key management device 20. In this case, the predetermined number is, for example, m+1. The predetermined number is not limited to m+1. For example, in the determination-making of the decentralized autonomous organization, in a case where the weight of the determination-making is different for each member and each member has a number of distributed keys corresponding to the weight of the determination-making, the predetermined number may be equal to or more than m+1.

In a case where the predetermined number is m+1, the generation unit 11 generates, for example, a secret key that can be restored by m+1 distributed keys, and m+1 distributed keys. For example, in a case where one distributed key held by the key management device 20 and m distributed keys are used, the generation unit 11 generates the secret key that can be restored. In addition, the m distributed keys are stored, for example, in a wallet shared by the members of the decentralized autonomous organization. The wallet is, for example, a virtual storage location that manages assets of the members of the decentralized autonomous organization. The wallet shared by the members of the decentralized autonomous organization is installed, for example, in a cloud environment.

In a case where the use request for data is permitted when the agreement of m or more members among n members (n is a positive integer) is obtained, the generation unit 11 may generate n+1 distributed keys. In this case, for example, when one distributed key stored in the key management device 20 and m or more distributed keys among n distributed keys are used, the generation unit 11 generates the secret key that can be restored. In a case where the secret key that can be restored is generated when one distributed key stored in the key management device 20 and m or more distributed keys among n distributed keys are used, the n distributed keys are allocated to n members one by one.

In a case where the distributed key is stored in the state of being encrypted by using the secret key, the generation unit 11 generates, for example, the secret key for the distributed key that encrypts the distributed key. That is, in a case where the distributed key is stored in the state of being encrypted by using the second secret key, the generation unit 11 generates, for example, the second secret key for encrypting the distributed key. For example, the generation unit 11 generates, as the second secret key, the secret key of each distributed key. Then, the generation unit 11 encrypts each distributed key, for example, by using the second secret key relevant to each distributed key. For example, it is assumed that the use request for data is permitted when the agreement of m or more members among n members is obtained. In this case, the predetermined number is m. The generation unit 11 generates, as the first secret key, the secret key that can be restored by m or more distributed keys among the n distributed keys. In addition, the generation unit 11 generates n distributed keys. When n distributed keys are generated, the generation unit 11 generates, as the second secret keys, the secret keys for the n distributed keys relevant to the respective distributed keys. Then, the generation unit 11 encrypts each distributed key by using the second secret key relevant to each distributed key. In a case where the secret key that can be restored by m distributed keys among the n distributed keys is generated as the first secret key, the second secret key is allocated to each member of the decentralized autonomous organization by the allocation unit 13, for example.

In a case where the distributed key is stored in the state of being encrypted by using the secret key, the generation unit 11 may generate, as the first secret key, the secret key that can be restored by m distributed keys. In this case, the generation unit 11 generates m distributed keys. In addition, the generation unit 11 generates, as the second secret keys, the secret keys for the m distributed keys relevant to the respective distributed keys. Then, the generation unit 11 encrypts each distributed key by using the second secret key relevant to each distributed key. In a case where the secret key that can restored by m distributed keys is generated as the first secret key, the second secret key is stored, for example, in the wallet shared by the members of the decentralized autonomous organization. The wallet shared by the members of the decentralized autonomous organization is installed, for example, in a cloud environment.

For example, the generation unit 11 regenerates the secret key (first secret key) when the data use by the user of which the use request is permitted is completed. For example, when the usage status of the data for which the use request is permitted satisfies a predetermined criterion, the generation unit 11 determines that the data use is completed. Then, when it is determined that the data use is completed, the generation unit 11 regenerates, for example, the secret key. The secret key is regenerated in the same manner as when the encrypted data is registered in the database of the data storage device 40. That is, after being used to encrypt data, the regenerated secret key is stored in the state of the distributed key. In addition, after being used to encrypt data, the generated secret key may be stored in the state of the distributed key encrypted by using the second secret key. The predetermined criterion is, for example, that data is used once. In a case where the predetermined criterion is, for example, that the data is used once, the generation unit 11 regenerates the secret key, for example, when the permitted data is used. The predetermined criterion may be, for example, that any one of a plurality of pieces of data is used. The predetermined criterion is, for example, a criterion for determining whether the usage status of the data has reached the upper limit of an allowed range. That is, the predetermined criterion is a criterion for determining that the data use by the user of the data has ended. The predetermined criterion is set as, for example, a criterion for determining whether the usage status of the data has reached the upper limit of the allowed range. How to set the predetermined criterion is not limited to the above. The predetermined criterion is set based on, for example, at least one of the number of times of data use, the amount of used data, or the use period of data. For example, the generation unit 11 regenerates the secret key when the number of times of use of the data for which the use request is permitted becomes equal to or more than the criterion. For example, when the data amount of the downloaded data becomes equal to or more than the criterion, the generation unit 11 regenerates the secret key for the data for which the use request is permitted. For example, when a period equal to or longer than the criterion has elapsed from the start of use of the data for which the use request is permitted, the generation unit 11 regenerates the secret key. The usage state of the data on which the setting of the predetermined criterion is based is not limited to the above. In addition, the predetermined criterion is set by, for example, a provider who registers data in the database.

The registration unit 12 registers the data encrypted by using the secret key generated by the generation unit 11 in the database of the data storage device 40. For example, the registration unit 12 registers the encrypted data and updates the encrypted data in such a way that all the data exists in the data storage device 40 in an encrypted state. For example, the registration unit 12 registers the encrypted data by outputting the data in the state of being encrypted using the secret key to the data storage device 40. In addition, for example, the registration unit 12 stores, in the storage unit 19, information for specifying the encrypted data on the database and information for specifying the distributed key used to encrypt the data in association with each other. Information in which the information for specifying the encrypted data on the database is associated with the secret key used to encrypt the data and the information for specifying the distributed key of the secret key may be added to a token used in the decentralized autonomous organization. The information for specifying data is, for example, at least one of an identifier of the data or a storage location of the data in the database. The information for specifying data is not limited to the above. In addition, the information for specifying the secret key and the distributed key is, for example, an identifier of the secret key and the distributed key. The information for specifying the secret key and the distributed key is not limited to the above.

In addition, in a case where the secret key is regenerated by the generation unit 11, the registration unit 12 re-encrypts, for example, the data registered in the data storage device 40 by using the regenerated secret key. For example, the registration unit 12 updates the data registered in the data storage device 40 by replacing the data registered in the data storage device 40 with the data encrypted by using the regenerated secret key. The registration unit 12 replaces the registered data by outputting, to the data storage device 40, the data in the state of being encrypted by using the regenerated secret key. The data to be registered in the data storage device 40 is input to the data management device 10 by the member of the decentralized autonomous organization, for example. In addition, for example, when the data encrypted by using the secret key is registered in the database of the data storage device 40, the registration unit 12 discards the secret key used for encryption.

In a case where the distributed key is managed in the state of being encrypted by the secret key for the distributed key, the allocation unit 13 allocates the secret key for the distributed key to, for example, the member of the decentralized autonomous organization. For example, in a case where the number of members of the decentralized autonomous organization is n and secret keys for n distributed keys are generated, the allocation unit 13 allocates the secret keys for the distributed keys one by one to the members of the decentralized autonomous organization, for example. The allocation of the secret key for the distributed key to each member of the decentralized autonomous organization may be determined when the generation unit 11 generates the distributed key or when the generation unit 11 generates the secret key for the distributed key.

In a case where the distributed keys are managed by storing some of the distributed keys in the key management device 20, the allocation unit 13 may allocate the distributed keys to be output to the key management device 20 among the distributed keys of the secret key used to encrypt the data. The allocation of the distributed keys to be output to the key management device 20 may be determined when the generation unit 11 generates the distributed keys.

The allocation unit 13 may allocate the distributed key stored in the wallet to the member who has agreed to the permission of the use request for the data. For example, in a case where m distributed keys are stored in the wallet, the allocation unit 13 allocates one distributed key to the member, who has agreed to the permission of the use request for the data, in the agreed order. In addition, the allocation unit 13 may allocate the secret key for the distributed key stored in the wallet to the member who has agreed to the permission of the use request for the data. For example, in a case where the secret keys for m distributed keys are stored in the wallet, the allocation unit 13 allocates the secret key for one distributed key to the member who has agreed to the permission of the data use, in the agreed order.

The output unit 14 outputs, to a distributed key acquisition unit 21 of the key management device 20, at least one distributed key among the distributed keys used to restore the secret key in a state where the secret key cannot be restored. The output unit 14 outputs, for example, to the distributed key acquisition unit 21 of the key management device 20, at least one distributed key among the distributed keys used to restore the secret key in a state where the secret key cannot be restored only with the distributed key. For example, the output unit 14 adds the identifier of the secret key relevant to the distributed key, and outputs the distributed key. For example, the output unit 14 may add the identifier of data encrypted with the secret key relevant to the distributed key and output the distributed key. For example, the output unit 14 outputs, to the distributed key acquisition unit 21 of the key management device 20, at least one distributed key among the distributed keys of the secret key generated by the generation unit 11. For example, the output unit 14 outputs, to the key management device 20, some distributed keys among the distributed keys necessary for restoring the secret key. For example, the output unit 14 outputs, to the distributed key acquisition unit 21 of the key management device 20, the distributed key allocated to the key management device 20 by the allocation unit 13. In addition, when the secret key is regenerated, the output unit 14 outputs, to the distributed key acquisition unit 21 of the key management device 20, at least one distributed key among the distributed keys of the secret key regenerated by the generation unit 11.

The output unit 14 may output a distributed key other than the distributed key allocated to the key management device 20 to the wallet of the decentralized autonomous organization. The wallet of the decentralized autonomous organization is installed, for example, in the cloud environment. The output unit 14 outputs the distributed key other than the distributed key allocated to the key management device 20, for example, to a storage area on the network. The output unit 14 may output the distributed key other than the distributed key allocated to the key management device 20 to the storage unit 19. In addition, the output unit 14 may output the distributed key other than the distributed key allocated to the key management device 20 to the data management device 10 other than an own device, based on the allocation by the allocation unit 13. In addition, when the secret key is regenerated, for example, the output unit 14 outputs, to the wallet of the decentralized autonomous organization, the distributed key other than the distributed key allocated to the key management device 20 among the distributed keys of the regenerated secret key.

The output unit 14 may output, to the distributed key acquisition unit 21 of the key management device 20, the distributed key in the state of being encrypted with the secret key for the distributed key. For example, the output unit 14 outputs all distributed keys of the secret key (first secret key) used to encrypt data, in the state of being encrypted with the secret keys (second secret key) for the distributed keys. For example, when the secret key is regenerated, the output unit 14 outputs, to the distributed key acquisition unit 21 of the key management device 20, the distributed keys of the regenerated secret key (first secret key) in the state of being encrypted with the secret keys (second secret key) for the distributed keys.

The output unit 14 outputs the secret key for the distributed key to the data management device 10 other than the own device, for example. The output unit 14 outputs the secret key for the distributed key to the data management device 10 other than the own device, based on the allocation by the allocation unit 13, for example. For example, when the secret key is regenerated, the output unit 14 outputs, to the data management device 10 other than the own device, the secret keys for the distributed keys regarding the distributed keys of the regenerated secret key. In addition, the output unit 14 may output the secret key for the distributed key to the wallet of the decentralized autonomous organization.

The acquisition unit 15 acquires, for example, a use request for the data registered in the database. The acquisition unit 15 acquires the use request for the data registered in the database, for example, from the user device 30. The use request for the data includes, for example, information for specifying data that the user desires to use. The use request for the data may further include information of at least one item among the number of times of use, the use frequency, and the use period of the data. The use request for the data may further include information regarding an amount of consideration paid by the user who makes the use request for the data. The information included in the use request for the data is not limited to the above.

The acquisition unit 15 acquires the distributed keys of the secret key used for encryption from the data management device 10 other than the own device, for example. In addition, for example, the acquisition unit 15 acquires, from the data management device 10 other than its own device, the secret keys (second secret key) for the distributed keys used to encrypt the distributed keys of the secret key (first secret key) used to encrypt data. In addition, the acquisition unit 15 acquires a token in the decentralized autonomous organization. The token includes, for example, information indicating that the use request for data has been received, information specifying the data for which the use request has been received, and information indicating whether another member agrees to the permission of the use request for the data. The information included in the token is not limited to the above.

In the intention expression on agreement or disagreement performed by each member of the decentralized autonomous organization, the determination unit 16 determines whether to agree to the permission of the use request for the data. For example, when the member of the decentralized autonomous organization inputs, to the data management device 10, information indicating that the permission of the use request for the data is approved, the determination unit 16 determines to agree to the permission of the use request for the data. The determination unit 16 may agree to the permission of the use request for the data when the use request for the data satisfies a predetermined agreement criterion. The predetermined agreement criterion is a criterion for determining whether to agree to the permission of the use request for the data. The predetermined agreement criterion is set, for example, by the user of the data management device 10. The predetermined agreement criterion is set, for example, by designating, among the data registered in the database, data that agrees to the permission of the use request for the data. The predetermined criterion may be set by using an attribute of data. The attribute of data is, for example, at least one of the contents of the data, the creation date of the data, or the format of the data. In addition, the predetermined agreement criterion may be set based on the amount of consideration paid by the user. In addition, the predetermined agreement criterion may be set based on the attribute of the user of the data. The attribute of the user of the data is at least one of affiliation of the user of the data, distinction between a student and an adult, age, occupation, or distinction between a professional and an armature. The predetermined agreement criterion may be set based on the purpose of use of the data. The purpose of the data is, for example, whether the data is for personal use, for commercial purposes, or for academic purposes.

For example, the determination unit 16 determines to permit the use request for the data when a predetermined number or a predetermined ratio of members among the members of the decentralized autonomous organization agree to the permission of the use request for the data. The predetermined number or the predetermined ratio is a criterion for determining whether to permit the use request for the data.

For example, when it is determined to agree to the permission of the use request for the data, the key output unit 17 outputs, to a restoration key acquisition unit 22 of the key management device 20, a key necessary for restoring the secret key relevant to the requested data. When it is determined to agree to the permission of the use request for the data, the key output unit 17 specifies the relevant secret key and the key necessary for restoring the secret key, based on the identifier of the data, for example. Then, for example, the key output unit 17 adds the identifier of the secret key to the key management device 20 and outputs the key necessary for restoring the secret key. In addition, for example, the key output unit 17 adds information for specifying the user device 30 used by the user who has made the use request for the data, and outputs the key necessary for restoring the secret key. For example, when it is determined to agree to the permission of the use request for the data, the key output unit 17 outputs, to the restoration key acquisition unit 22 of the key management device 20, the distributed key as the key necessary for restoring the secret key. For example, the key output unit 17 outputs, as the key necessary for restoring the secret key, the distributed key allocated to the own device. For example, the key output unit 17 outputs, as the key necessary for restoring the secret key, the distributed key stored in the wallet shared by the members of the decentralized autonomous organization. In addition, in the case of outputting the distributed key stored in the wallet, the key output unit 17 may further output, to the restoration key acquisition unit 22 of the key management device 20, a certificate associated with the member who has permitted the use request for the data. The certificate is, for example, information that certifies that the member who agrees to the permission of the use request for the data is a member of the decentralized autonomous organization.

For example, when it is determined to agree to the permission of the use request for the data, the key output unit 17 outputs, to the restoration key acquisition unit 22 of the key management device 20, the secret key (second secret key) for the distributed key as the key necessary for restoring the secret key (first secret key). For example, the key output unit 17 outputs, as the key necessary for restoring the secret key, the secret key for the distributed key allocated to the own device. For example, the key output unit 17 may output, as the key necessary for restoring the secret key, the secret key for the distributed key stored in the wallet shared by the members of the decentralized autonomous organization.

When a predetermined number of members among the members of the decentralized autonomous organization agree to the permission of the use request for the data, the permission certificate output unit 18 outputs the use permission certificate of the requested data to the user device 30 used by the person who has made the use request for the data. The use permission certificate includes, for example, information specifying the data permitted to be used and a use condition, and the use condition includes, for example, the information of at least one of the number of available times, an amount of available data, or an available period. The information included in the use permission certificate is not limited to the above. In addition, the use condition is not limited to the above. For example, in the case of first acquiring the use request for the data, the permission certificate output unit 18 outputs the use permission certificate of the requested data to the user device 30. In a case where the permission certificate output unit 18 acquires the use request for the data registered in the data storage device 40 by the own device, the permission certificate output unit may output the use permission certificate of the requested data to the user device 30. The permission certificate output unit 18 may refer to the token of the decentralized autonomous organization, and output the use permission certificate of the requested data to the user device 30 in a case where the number of members necessary for determining the permission of the use request for the data is satisfied upon the agreement in the own device.

For example, the storage unit 19 stores information regarding the registration of data and the permission of the use request for the data. The storage unit 19 stores, for example, the allocated distributed key. In addition, the storage unit 19 may store, for example, the secret key for the distributed key. In addition, the storage unit 19 stores, for example, the information for specifying the encrypted data on the database and the information for specifying the distributed key used to encrypt the data in association with each other. In addition, the storage unit 19 stores, for example, a history regarding the permission of the use request for the data. The history regarding the permission of the use request for the data includes, for example, the user, the data permitted to be used, and the use condition. The information included in the history regarding the use permission regarding the data is not limited to the above.

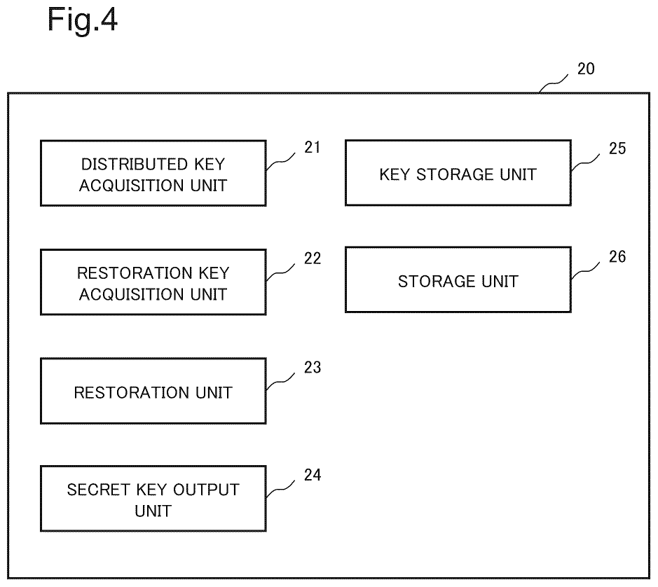

Next, a specific example of the configuration of the key management device 20 will be described. FIG. 4 is a diagram illustrating an example of a configuration of the key management device 20. The key management device 20 includes the distributed key acquisition unit 21, the restoration key acquisition unit 22, a restoration unit 23, and a secret key output unit 24 as a basic configuration. In addition, the key management device 20 includes, for example, a key storage unit 25 and a storage unit 26.

For example, the distributed key acquisition unit 21 acquires at least one distributed key among the distributed keys of the secret key that is used to encrypt the data registered in the database and can be restored with a predetermined number of distributed keys. Here, the secret key corresponds to the first secret key. For example, the distributed key acquisition unit 21 acquires at least one distributed key among the distributed keys of the secret key that can be restored with a predetermined number of distributed keys in a state where the secret key cannot be restored with only the at least one distributed key. For example, the distributed key acquisition unit 21 stores the acquired distributed key in the key storage unit 25. For example, the distributed key acquisition unit 21 acquires the distributed key in a state where the identifier of the secret key relevant to the distributed key is added.

For example, the distributed key acquisition unit 21 acquires one distributed key of the secret key used for encryption, from the output unit 14 of the data management device 10 that has encrypted data. The distributed key acquisition unit 21 acquires one distributed key among the distributed keys of the secret key that can be restored with a predetermined number of distributed keys. In this case, in the decentralized autonomous organization, when the data use is permitted with the agreement of m members, the predetermined number is, for example, m+1. That is, the distributed key acquisition unit 21 acquires one distributed key among the distributed keys of the secret key that can be restored with m+1 distributed keys. In this case, for example, in a state where one distributed key is acquired, the restoration unit 23 cannot restore the secret key. In addition, for example, in a case where the number of members of the decentralized autonomous organization is n, the secret key used for encryption may be a secret key that can be restored when m or more distributed keys among n distributed keys and one distributed key stored in the key storage unit 25 are obtained.

The distributed key acquisition unit 21 may acquire each distributed key of the secret key (first secret key) that can be restored with a predetermined number of distributed keys, in a state of being encrypted with the secret key (second secret key) for the distributed key. In this case, in the decentralized autonomous organization, when the data use is permitted with the agreement of m members, the predetermined number is, for example, m. In a case where the number of members of the decentralized autonomous organization is n, the secret key used for encryption is, for example, a secret key that can be restored when m or more distributed keys among n distributed keys are obtained. For example, the distributed key acquisition unit 21 acquires each of the n distributed keys in the state of being encrypted by using the secret key for the distributed key. In addition, the distributed key acquisition unit 21 may acquire each of the m distributed keys in the state of being encrypted by using the secret key for the distributed key.

The restoration key acquisition unit 22 acquires, for example, a key necessary for restoring the secret key used to encrypt the data, from the key output unit 17 of the data management device 10 that has determined to agree to the permission of the use request for the data. Here, The data management device 10 is, for example, a device that each member of the decentralized autonomous organization that permits the use request for the data based on the agreement of a plurality of members uses to express an intention indicating whether to agree to the permission of the use request for the data. The restoration key acquisition unit 22 acquires, for example, a distributed key other than the distributed key stored in the key storage unit 25 among the distributed keys necessary for restoring the secret key. For example, in a case where one distributed key among the distributed keys of the secret key that can be restored with m+1 distributed keys is stored in the key storage unit 25, the restoration key acquisition unit 22 acquires the distributed keys included in the m distributed keys one by one from the data management devices 10 that have agreed to provide data. In addition, in a case where m or more distributed keys among the n distributed keys and the secret key that can be restored when one distributed key stored in the key storage unit 25 is obtained are used, the restoration key acquisition unit 22 acquires the distributed keys included in the n distributed keys one by one from the data management devices 10 that have agreed to provide data. In addition, when acquiring a key necessary for restoring the secret key from the key output unit 17 of the data management device 10, the restoration key acquisition unit 22 may further acquire the certificate associated with the member who has permitted to use the data. For example, when acquiring the distributed key stored in the wallet from the key output unit 17 of the data management device 10, the restoration key acquisition unit 22 acquires, as the certificate, information certifying that the member who has permitted to use the data is the member of the decentralized autonomous organization.

The restoration key acquisition unit 22 may acquire the secret key (second secret key) for the distributed key as the key necessary for restoring the secret key (first secret key) used to encrypt the data. In a case where each of the n distributed keys is stored in the key storage unit 25 in the state of being encrypted by using the secret key for the distributed key, the restoration key acquisition unit 22 acquires the secret keys for the distributed keys included in the secret keys for the n distributed keys one by one from the data management devices 10 that have agreed to provide data. In addition, in a case where each of the m distributed keys is stored in the state of being encrypted by using the secret key for the distributed key, the restoration key acquisition unit 22 acquires the secret key for one distributed key among the secret keys of the m distributed key secret keys from each of the data management devices 10 that have agreed to provide data.

For example, the restoration unit 23 restores the secret key based on the distributed key and the key necessary for restoring the secret key. The restoration unit 23 restores the secret key, for example, by using the distributed key that matches the added identifier of the secret key. The restoration unit 23 restores the secret key, for example, based on the distributed key stored in the key storage unit 25 and the distributed key acquired by the restoration key acquisition unit 22. In a case where the secret key can be restored with m distributed keys and one distributed key stored in the key storage unit 25, the restoration unit 23 restores the secret key based on m+1 distributed keys when the m distributed keys are acquired. In a case where the distributed key is encrypted with the secret key for the distributed key, the restoration unit 23 decrypts a predetermined number of encrypted distributed keys by using a predetermined number of secret keys for the distributed keys. Then, the restoration unit 23 restores the secret key used to encrypt data by using the predetermined number of decrypted distributed keys. The predetermined number is the number of distributed keys required to restore the secret key. The restoration unit 23 decrypts the distributed key by using the secret key for the distributed key acquired by the restoration key acquisition unit 22. Then, in a case where the predetermined number is m, the restoration unit 23 restores the secret key by using the m distributed keys when the m distributed keys are decrypted.

The restoration unit 23 may restore the secret key when acquiring the certificate relevant to each of the members who have agreed to the permission of the use request for the data. The restoration unit 23 restores the secret key, for example, by using the distributed key to which the certificate is added. For example, in a case where the restoration key acquisition unit 22 acquires the distributed key stored in the wallet, the restoration unit 23 restores the secret key by using, among the distributed keys acquired by the restoration key acquisition unit 22, the distributed key to which the certificate is added. The certificate is, for example, information indicating that the member who has agreed to the permission of the use request for the data is a member of the decentralized autonomous organization. In addition, for example, the restoration unit 23 excludes a distributed key to which no certificate is added, among the distributed keys acquired by the restoration key acquisition unit 22, from the distributed keys used for restoring the secret key.

The secret key output unit 24 outputs, for example, the secret key restored by the restoration unit 23. The secret key output unit 24 outputs the restored secret key to, for example, the user device 30 used by the user who has made the use request for the data. The information for specifying the user device 30 used by the user who has made the use request for the data is added to, for example, the key necessary for restoring the secret key acquired by the restoration key acquisition unit 22.

In addition, in a case where the secret key cannot be restored, the secret key output unit 24 may output, to the user device 30 used by the user who has made the use request for the data, information indicating that the use request for the data is not permitted. In addition, in a case where the secret key cannot be restored, the secret key output unit 24 may output, to the data management device 10, information indicating that the secret key cannot be restored.

The key storage unit 25 stores, for example, the distributed key of the secret key used to encrypt data. The key storage unit 25 stores, for example, the distributed key acquired by the distributed key acquisition unit 21. In addition, the key storage unit 25 stores, for example, the distributed key encrypted with the secret key for the distributed key acquired by the distributed key acquisition unit 21. The key storage unit 25 stores, for example, the distributed key acquired by the restoration key acquisition unit 22. In addition, the key storage unit 25 stores, for example, the secret key for the distributed key acquired by the restoration key acquisition unit 22.

The storage unit 26 stores, for example, data regarding the restoration of the secret key. The storage unit 26 stores, for example, information that can specify the encrypted data on the database and information that specifies the distributed key relevant to the encrypted data in association with each other.

The user device 30 is, for example, an information processing device that a user who uses data registered in the database uses to make a use request for data and to acquire permitted data. The user device 30 outputs the use request for data to the data management device 10, for example. The use request for data is input to the user device 30 by the user who uses the data, for example. The use request for data includes, for example, information for specifying data that the user desires to use. The use request for data may include information of at least one item among the number of times of use of the data, the use amount of the data, and the use period of the data.

For example, in a case where the use request for the data is permitted, the user device 30 acquires the secret key from the key management device 20. In addition, for example, in a case where the use request for the data is permitted, the user device 30 further acquires the use permission certificate of the data from the data management device 10.

The user device 30 outputs the use permission certificate of the data to the data storage device 40, for example. Then, the user device 30 acquires, for example, the data permitted to be used from the data storage device 40. The user device 30 decrypts the data acquired from the data storage device 40, for example, by using the secret key acquired from the key management device 20.

When the use of the data is completed, the user device 30 may output, to the data management device 10, information indicating that the use of the data is completed. The user device 30 outputs the information indicating that the use of the data is completed, for example, to the data management device 10 that has issued the use permission certificate of the data.

As the user device 30, for example, a personal computer, a server, a tablet computer, a smartphone, or a wearable terminal device is used. The example of the information processing device used for the user device 30 is not limited to the above.

The data storage device 40 stores, for example, encrypted data. The data storage device 40 includes, for example, a controller that manages data and a storage means. The storage means may be a plurality of storage devices connected via the network. The data storage device 40 may be a data space on the network. The data storage device 40 stores, for example, encrypted data in the state of being registered in the database. For example, the data storage device 40 acquires, from the user device 30, the use permission certificate indicating that the use request for the data is permitted, and the request for data. Then, the data storage device 40 searches the database for the data designated by the use permit, and the data storage device 40 outputs the data designated by the use permission certificate to the user device 30, for example.

The data storage device 40 outputs the data based on a predetermined criterion regarding the data use designated by the use permission certificate. The predetermined criterion regarding the data use is, for example, information indicating the use condition of the data. The predetermined criterion regarding the data use is set, for example, based on at least one of the number of available times, an amount of available data, or an available period. The predetermined criterion regarding the data use is a criterion indicating an upper limit of at least one of the number of available times, the data amount, or the period. How to set the predetermined criterion regarding the data use is not limited to the above.

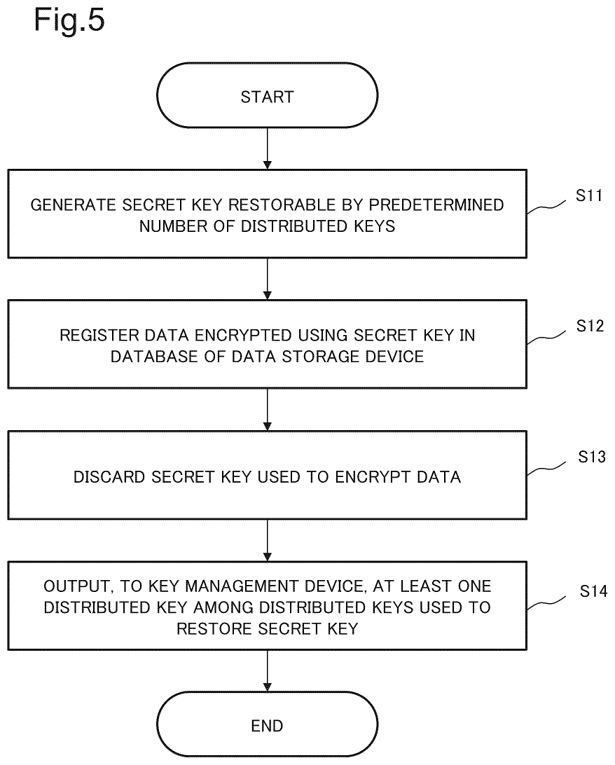

An example of an operation in which the data management device 10 registers encrypted data in the data storage device 40 will be described. FIG. 5 is a diagram illustrating an example of an operation flow of the data management device 10 at the time of performing processing of registering encrypted data in the data storage device 40.

The generation unit 11 generates a secret key that can be restored by a predetermined number of distributed keys (step S11). The generation unit 11 generates, for example, the secret key that can be restored by the predetermined number of distributed keys and the predetermined number of distributed keys.

When the secret key is generated, the registration unit 12 registers the data encrypted by using the secret key in the database of the data storage device 40 (step S12). When the encrypted data is registered, for example, the registration unit 12 discards the secret key used to encrypt the data when the data encrypted by using the secret key is registered in the database of the data storage device 40 (step S13).

When the encrypted data is registered in the database, the output unit 14 outputs, to the key management device 20, at least one distributed key among the distributed keys used to restore the secret key (step S14). The output unit 14 outputs, to the key management device 20, at least one distributed key among the distributed keys used to restore the secret key in a state where the secret key cannot be restored only with the at least one distributed key.

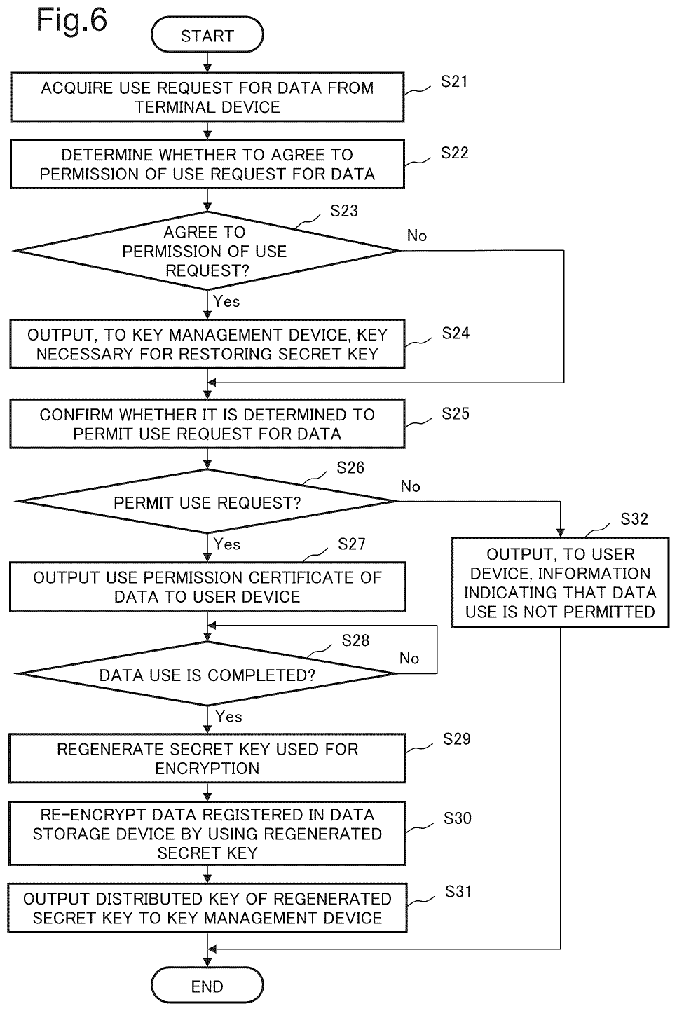

An example of an operation in which the data management device 10 permits the use request for the data will be described. FIG. 6 is a diagram illustrating an example of an operation flow of the data management device 10 at the time of performing processing regarding the permission of the use request for the data. In the following description, it is assumed that the data management device 10 performs re-encryption, for example, after completion of the data use by the user.

The acquisition unit 15 acquires the use request for the data (step S21). The acquisition unit 15 acquires the use request for the data, for example, from the user device 30.

When the use request for the data is acquired, as the member of the decentralized autonomous organization, the determination unit 16 determines whether to agree to the permission of the use request for the data (step S22).

In a case where it is determined to agree to the permission of the use request for the data (Yes in step S23), the key output unit 17 outputs, to the key management device 20, a key necessary for restoring the secret key relevant to the requested data (step S24).

When the key necessary for restoring the secret key is output, the permission certificate output unit 18 confirms, for example, whether it is determined to permit the use request for the data (step S25). The permission certificate output unit 18 refers to, for example, the token of the decentralized autonomous organization, and confirms whether a required number of members for permitting the use request for the data have agreed to the permission of the use request for the data. In a case where it is determined to permit the use request for the data (Yes in step S26), the permission certificate output unit 18 outputs the use permission certificate of the data to the user device 30, for example (step S27).

In addition, in step S23, in a case where it is determined not to agree to the permission of the use request for the data (No in step S23), the processing of step S25 and subsequent steps is performed.

When the use of the data is completed in the user device 30 (Yes in step S28) after the output of the use permission certificate of the data in step S27, the generation unit 11 regenerates the secret key used to encrypt the data (step S29).

When the secret key is regenerated, the registration unit 12 re-encrypts the data registered in the database of the data storage device 40 by using the regenerated secret key (step S30).

When the data is re-encrypted, the output unit 14 outputs at least one distributed key of the regenerated secret key to the key management device 20 (step S31).

In step S28, in a case where the use of the data is not completed in the user device 30 (No in step S28), the data management device 10 waits until the use of the data is completed.

In addition, in a case where it is determined in step S26 by the decentralized autonomous organization that the use request for the data is not permitted (No in step S26), the permission certificate output unit 18 outputs, to the user device 30, information indicating that the data use request is not permitted, for example (step S32).

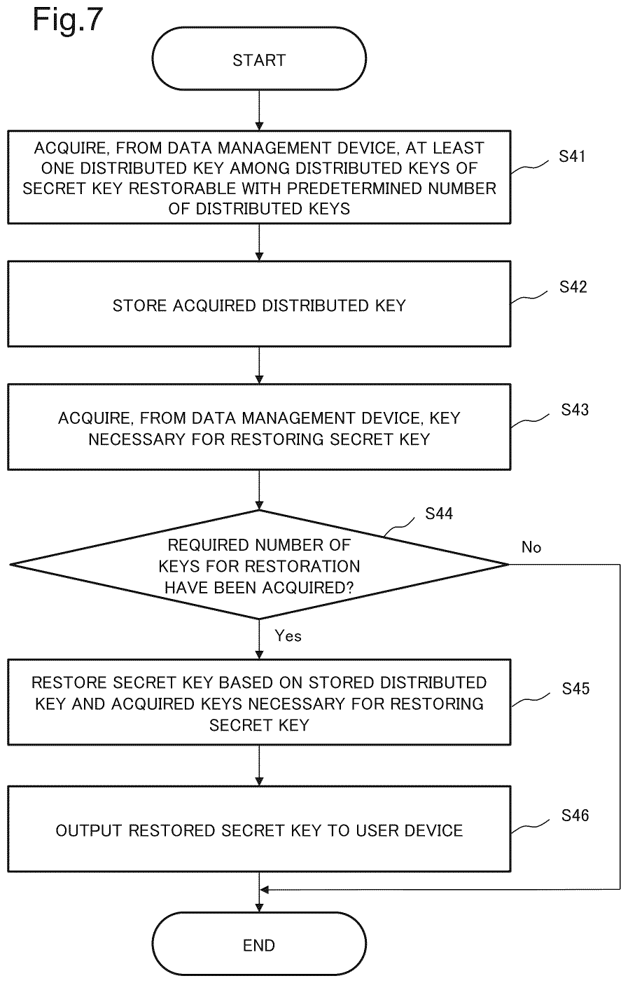

An operation when the key management device 20 stores the distributed key and restores the secret key will be described. FIG. 7 is a diagram illustrating an example of an operation flow of the key management device 20 at the time of performing processing regarding the storage of the distributed key and the restoration of the secret key.

The distributed key acquisition unit 21 acquires at least one distributed key among the distributed keys of the secret key that is used to encrypt the data registered in the database and can be restored with a predetermined number of distributed keys (step S41). For example, the distributed key acquisition unit 21 acquires, from the data management device 10, the distributed key or the distributed key encrypted with the secret key for the distributed key.

When the distributed key is acquired, for example, the key storage unit 25 stores the distributed key acquired by the distributed key acquisition unit 21 (step S42).

In addition, the restoration key acquisition unit 22 acquires the key necessary for restoring the secret key from the data management device 10 (step S43). When a required number of keys for restoring the secret key are acquired (Yes in step S44), the restoration unit 23 restores the secret key based on the stored distributed key and the acquired keys necessary for restoring the secret key (step S45). When the secret key is restored, the secret key output unit 24 outputs the restored secret key to the user device 30 that has made the use request for the data (step S46).

In step S44, in a case where the required number of keys for restoring the secret key have not been acquired (No in step S44), the restoration unit 23 determines that the secret key cannot be restored. When it is determined that the secret key cannot be restored, the key management device 20 ends the processing regarding the restoration of the secret key.

The data management device 10 encrypts the data by using the secret key and registers the result in the database of the data storage device 40. In addition, the data management device 10 outputs at least one of the distributed keys of the secret key to the key management device 20. For example, the data management device 10 outputs, to the key management device 20, some distributed keys among the distributed keys necessary for restoring the secret key. In addition, the data management device 10 outputs, to the key management device 20, the distributed key encrypted with the secret key for the distributed key, for example. As described above, by managing the distributed key necessary for decrypting the encrypted data, the data management device other than the data management device 10 having performed the encryption and the key management device 20 cannot decrypt the encrypted data on the database. In addition, the data storage device 40 cannot decrypt the encrypted data on the database. In addition, the user device 30 cannot decrypt the encrypted data except when the use of the data is permitted and the restored secret key is acquired. As described above, the decryption of the encrypted data registered in the database can be restricted, so that it is possible to suppress the leakage of the data while facilitating the use of the data.

In addition, after the use of the data is completed, the data management device 10 encrypts the data of the database again by using the regenerated secret key. Thus, there is no secret key that can decrypt the data in the user device 30 and the key management device 20. That is, the user device 30 and the key management device 20 cannot decrypt the data at timings other than a timing at which the use is permitted, so that the leakage of the data can be further suppressed.

Each processing in the data management device 10 may be executed in a distributed manner in a plurality of information processing devices connected via the network. For example, the processing regarding the encryption of the data and the processing regarding the use permission of the data may be performed in another information processing device. For example, the processing in the generation unit 11, the registration unit 12, the allocation unit 13, and the output unit 14 and the processing in the acquisition unit 15, the determination unit 16, the key output unit 17, and the permission certificate output unit 18 may be performed in another information processing device. Which information processing device performs each processing in the data management device 10 can be appropriately set.

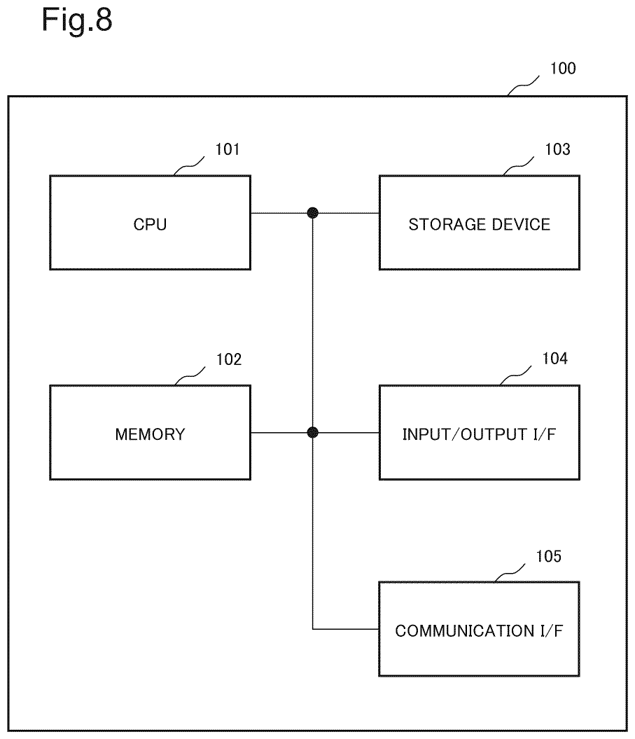

Each processing in the data management device 10 can be achieved by executing a computer program on a computer. FIG. 8 illustrates an example of a configuration of a computer 100 that executes a computer program for performing each processing in the data management device 10. The computer 100 includes a central processing unit (CPU) 101, a memory 102, a storage device 103, an input/output interface (I/F) 104, and a communication I/F 105.

The CPU 101 reads and executes a computer program for performing each processing from the storage device 103. The CPU 101 may be configured by a combination of a plurality of CPUs. The memory 102 includes a dynamic random access memory (DRAM) or the like, and temporarily stores the computer program executed by the CPU 101 and data being processed. The storage device 103 stores the computer program executed by the CPU 101. The storage device 103 includes, for example, a nonvolatile semiconductor storage device. As the storage device 103, another storage device such as a hard disk drive may be used. The input/output I/F 104 is an interface that receives an input from an operator and outputs display data and the like. The communication I/F 105 is an interface that transmits and receives data to and from the key management device 20, the data storage device 40, and the user device 30. In addition, the key management device 20, the data storage device 40, and the user device 30 may be configured similarly to the computer 100.

The computer program used for executing each processing can also be stored and distributed on a computer-readable recording medium that non-transitorily records data. As the recording medium, for example, a magnetic tape for data recording or a magnetic disk such as a hard disk can be used. In addition, as the recording medium, an optical disk such as a compact disc read only memory (CD-ROM) can also be used. A non-volatile semiconductor storage device may be used as the recording medium.

Data transactions may be performed via a database arranged in a storage device on the network. The transacted data is registered in the database, for example, by a provider of the data. Then, for example, the user acquires the data from the database after receiving permission from the provider. In addition, in a case where the data is stored in the database on the network, it may be necessary to ensure the confidentiality of the data. For example, in order to prevent leakage of contents of the data and unauthorized use of the data, it is necessary to manage the data stored in the database in a confidential state. However, for example, with the technology described in the background art, it may be difficult to ensure the confidentiality of data to be provided.

In this regard, in order to solve the above problem, an object of the present disclosure is to provide a data management device and the like capable of suppressing data leakage.

For example, the data leakage can be suppressed by using the data management device and the like of the present disclosure.

Some or all of the above-described example embodiments may be described as the following supplementary notes, but are not limited to the following.

### Supplementary Note 1

A data management device including:
a generation unit that generates a first secret key that is restorable by a predetermined number of distributed keys;
a registration unit that registers data encrypted by using the first secret key in a database of a data storage device;
an output unit that outputs at least one distributed key among distributed keys used to restore the first secret key to a key management device that stores the distributed key and restores the first secret key;
an acquisition unit that acquires a use request for the data registered in the database;
a determination unit that determines whether to agree to permission of the use request for the data in intention expression on agreement or disagreement performed by each member of an organization that permits the use request for the data based on agreement of a plurality of members; and
a key output unit that outputs, to the key management device, a key necessary for restoring the first secret key relevant to the requested data when it is determined to agree to the permission of the use request for the data.

### Supplementary Note 2

The data management device according to supplementary note 1, wherein the output unit outputs, to the key management device, each of the distributed keys in a state of being encrypted with a second secret key, and the key output unit outputs the second secret key as the key necessary for restoring the first secret key.

### Supplementary Note 3

The data management device according to supplementary note 1, wherein the key output unit outputs, as the key necessary for restoring the first secret key, one distributed key among the distributed keys shared and held among the members of the organization.

### Supplementary Note 4

The data management device according to supplementary note 3, wherein the key output unit further outputs, to the key management device, a certificate that certifies that a member who has agreed to the permission of the use request for the data is the member of the decentralized autonomous organization.

### Supplementary Note 5

The data management device according to any one of supplementary notes 1 to 4, wherein
the generation unit regenerates the first secret key when use of data by a permitted user is completed,
the registration unit encrypts used data registered in the data storage device by using the regenerated first secret key, and
the output unit outputs, to the key management device, at least one distributed key among distributed keys of the regenerated first secret key.

### Supplementary Note 6

The data management device according to any one of supplementary notes 1 to 4, wherein
when a predetermined number of members among the members of the organization agree to the permission of the use request for the data, a use permission certificate indicating that the use request for the data is permitted is output to a user device used by a user who has made the use request for the data.

### Supplementary Note 7

The data management device according to supplementary note 6, wherein
the use permission certificate includes at least one of information for specifying data permitted to be used or information regarding a use condition of the data.

### Supplementary Note 8

The data management device according to any one of supplementary notes 1 to 4, wherein
the organization is a decentralized autonomous organization.

### Supplementary Note 9

A key management device including:
a distributed key acquisition unit that acquires at least one distributed key among distributed keys of a first secret key that is used to encrypt data registered in a database and is restorable with a predetermined number of distributed keys;
a restoration key acquisition unit that acquires a key necessary for restoring the first secret key from a data management device that has determined to agree to permission of the use request for the data in intention expression on agreement or disagreement performed by each member of a decentralized autonomous organization that permits the use request for the data based on agreement of a plurality of members;
a restoration unit that restores the first secret key based on the distributed key and the key necessary for restoring the first secret key; and
a secret key output unit that outputs the restored first secret key to a user device used by a user who has made the use request for the data.

### Supplementary Note 10

The key management device according to supplementary note 9, wherein
the distributed key acquisition unit acquires each distributed key of a secret key that is restorable with the predetermined number of distributed keys in a state of being encrypted with a secret key for the distributed key,
the restoration key acquisition unit acquires the secret key for the distributed key as the key necessary for restoring the secret key, and
the restoration unit decrypts the predetermined number of encrypted distributed keys by using the secret keys for the predetermined number of distributed keys, and restores the secret key used to encrypt data by using the predetermined number of decrypted distributed keys.

### Supplementary Note 11

The key management device according to supplementary note 9, wherein
the restoration key acquisition unit acquires, from each of the data management devices used by members who have permitted to use the data, one distributed key among the distributed keys shared and held among the members as the key necessary for restoring the secret key, and
the restoration unit restores the secret key used to encrypt the data by using the predetermined number of distributed keys.

### Supplementary Note 12

The key management device according to supplementary note 11, wherein
a certificate associated with the member who has permitted to use the data is further acquired when the key necessary for restoring the secret key is acquired, and
the secret key is restored when the certificate relevant to each member who has permitted to use the data is acquired.

### Supplementary Note 13

A data management method including:
generating a first secret key that is restorable by a predetermined number of distributed keys;
registering data encrypted by using the first secret key in a database of a data storage device;
outputting at least one distributed key among distributed keys used to restore the first secret key to a key management device that stores the distributed key and restores the first secret key;
acquiring a use request for the data registered in the database;
determining whether to agree to permission of the use request for the data in intention expression on agreement or disagreement performed by each member of an organization that permits the use request for the data based on agreement of a plurality of members; and
outputting, to the key management device, a key necessary for restoring the first secret key relevant to the requested data when it is determined to agree to the permission of the use request for the data.

### Supplementary Note 14

A key management method including:
acquiring at least one distributed key among distributed keys of a first secret key that is used to encrypt data registered in a database and is restorable with a predetermined number of distributed keys;
acquiring a key necessary for restoring the first secret key from a data management device that has determined to agree to permission of the use request for the data in intention expression on agreement or disagreement performed by each member of an organization that permits the use request for the data based on agreement of a plurality of members;
restoring the first secret key based on the distributed key and the key necessary for restoring the first secret key; and
outputting the restored first secret key to a user device used by a user who has made the use request for the data.

### Supplementary Note 15

A data management program for causing a computer to execute:
a process of generating a first secret key that is restorable by a predetermined number of distributed keys;
a process of registering data encrypted by using the first secret key in a database of a data storage device;
a process of outputting at least one distributed key among distributed keys used to restore the first secret key to a key management device that stores the distributed key and restores the first secret key;
a process of acquiring a use request for the data registered in the database;
a process of determining whether to agree to permission of the use request for the data by a member of an organization that permits the use request for the data based on agreement of a plurality of members; and
a process of outputting, to the key management device, a key necessary for restoring the first secret key relevant to the data when it is determined to agree to the permission of the use request for the data.

### Supplementary Note 16

A recording medium that non-transitorily records a key management program for causing a computer to execute:
a process of acquiring at least one distributed key among distributed keys of a first secret key that is used to encrypt data registered in a database and is restorable with a predetermined number of distributed keys;
a process of acquiring a key necessary for restoring the first secret key from a data management device that has determined to agree to permission of the use request for the data in intention expression on agreement or disagreement performed by each member of an organization that permits the use request for the data based on agreement of a plurality of members;
a process of restoring the first secret key based on the distributed key and the key necessary for restoring the first secret key; and
a process of outputting the restored first secret key to a user device used by a user who has made the use request for the data.

In addition, some or all of the configurations described in supplementary notes 2 to 8 dependent on supplementary note 1 described above can also be dependent on supplementary notes 13 and 15 by the same dependency relationship as supplementary notes 2 to 8. Furthermore, not only supplementary notes 1, 3, and 15, but also various pieces of hardware, software, various recording means for recording software, or systems can be similarly dependent on some or all of the configurations described as supplementary notes without departing from the above-described embodiments.

In addition, some or all of the configurations described in supplementary notes 10 to 12 dependent on supplementary note 9 described above can be dependent on supplementary notes 14 and 16 by the same dependency relationship as supplementary notes 10 to 12. Furthermore, not only supplementary notes 9, 14, and 16, but also various pieces of hardware, software, various recording means for recording software, or systems can be similarly dependent on some or all of the configurations described as supplementary notes without departing from the above-described embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A data management device comprising:
at least one memory storing instructions; and
at least one processor configured to access the at least one memory and execute the instructions to:
generate a first secret key that is restorable by a predetermined number of distributed keys;
register data encrypted by using the first secret key in a database of a data storage device;
output at least one distributed key among distributed keys used to restore the first secret key to a key management device that stores the distributed key and restores the first secret key;
acquire a use request for the data registered in the database;
determine whether to agree to permission of the use request for the data in intention expression on agreement or disagreement performed by each member of an organization that permits the use request for the data based on agreement of a plurality of members; and
output, to the key management device, a key necessary for restoring the first secret key relevant to the requested data when it is determined to agree to the permission of the use request for the data.

2. The data management device according to claim 1, wherein
the at least one processor is further configured to execute the instructions to:
output, to the key management device, each of the distributed keys in a state of being encrypted with a second secret key, and
output the second secret key as the key necessary for restoring the first secret key.

3. The data management device according to claim 1, wherein
the at least one processor is further configured to execute the instructions to:
output, as the key necessary for restoring the first secret key, one distributed key among the distributed keys shared and held among the members of the organization.

4. The data management device according to claim 3, wherein
the at least one processor is further configured to execute the instructions to:
output, to the key management device, a certificate that certifies that a member who has agreed to the permission of the use request for the data is the member of the organization.

5. The data management device according to claim 1, wherein
the at least one processor is further configured to execute the instructions to:
regenerate the first secret key when use of data by a permitted user is completed,
encrypt used data registered in the data storage device by using the regenerated first secret key, and
output, to the key management device, at least one distributed key among distributed keys of the regenerated first secret key.

6. The data management device according to claim 1, wherein
the at least one processor is further configured to execute the instructions to:
when a predetermined number of members among the members of the organization agree to the permission of the use request for the data, output a use permission certificate indicating that the use request for the data is permitted to a user device used by a user who has made the use request for the data.

7. The data management device according to claim 6, wherein
the use permission certificate includes at least one of information for specifying data permitted to be used or information regarding a use condition of the data.

8. The data management device according to claim 1, wherein
the organization is a decentralized autonomous organization.

9. A key management device comprising:
at least one memory storing instructions; and
at least one processor configured to access the at least one memory and execute the instructions to:
acquire at least one distributed key among distributed keys of a first secret key that is used to encrypt data registered in a database and is restorable with a predetermined number of distributed keys;
acquire a key necessary for restoring the first secret key from a data management device that has determined to agree to permission of the use request for the data in intention expression on agreement or disagreement performed by each member of an organization that permits the use request for the data based on agreement of a plurality of members;
restore the first secret key based on the distributed key and the key necessary for restoring the first secret key; and
output the restored first secret key to a user device used by a user who has made the use request for the data.

10. The key management device according to claim 9, wherein
the at least one processor is further configured to execute the instructions to:
acquire each distributed key of a secret key that is restorable with the predetermined number of distributed keys in a state of being encrypted with a secret key for the distributed key,
acquire the secret key for the distributed key as the key necessary for restoring the secret key, and
decrypt the predetermined number of encrypted distributed keys by using the secret keys for the predetermined number of distributed keys, and restores the secret key used to encrypt data by using the predetermined number of decrypted distributed keys.

11. The key management device according to claim 9, wherein
the at least one processor is further configured to execute the instructions to:
acquire, from each of the data management devices used by members who have permitted to use the data, one distributed key among the distributed keys shared and held among the members as the key necessary for restoring the secret key, and
restore the secret key used to encrypt the data by using the predetermined number of distributed keys.

12. The key management device according to claim 11, wherein
a certificate associated with the member who has permitted to use the data is further acquired when the key necessary for restoring the secret key is acquired, and
the secret key is restored when the certificate relevant to each member who has permitted to use the data is acquired.

13. A data management method comprising:
generating a first secret key that is restorable by a predetermined number of distributed keys;
registering data encrypted by using the first secret key in a database of a data storage device;
outputting at least one distributed key among distributed keys used to restore the first secret key to a key management device that stores the distributed key and restores the first secret key;
acquiring a use request for the data registered in the database;
determining whether to agree to permission of the use request for the data in intention expression on agreement or disagreement performed by each member of an organization that permits the use request for the data based on agreement of a plurality of members; and
outputting, to the key management device, a key necessary for restoring the first secret key relevant to the requested data when it is determined to agree to the permission of the use request for the data.

14. The data management method according to claim 13, further comprising:
outputting each of the distributed keys to the key management device in a state of being encrypted with a second secret key; and
outputting the second secret key as the key necessary for restoring the first secret key.

15. The data management method according to claim 13, further comprising:
outputting one distributed key among the distributed keys shared and held among the members of the organization as the key necessary for restoring the first secret key.

16. The data management method according to claim 15, further comprising:
outputting a certificate that certifies that a member who has agreed to the permission of the use request for the data is the member of the organization to the key management device.

17. The data management method according to claim 13, further comprising:
generating the first secret key when use of data by a permitted user is completed;
encrypting used data registered in the data storage device by using the regenerated first secret key; and
outputting at least one distributed key among distributed keys of the regenerated first secret key to the key management device.

18. The data management method according to claim 13, further comprising:
when a predetermined number of members among the members of the organization agree to the permission of the use request for the data,
outputting a use permission certificate indicating that the use request for the data is permitted to a user device used by a user who has made the use request for the data.

19. The data management method according to claim 17, wherein
the use permission certificate includes at least one of information for specifying data permitted to be used or information regarding a use condition of the data.

20. A key management method comprising:
acquiring at least one distributed key among distributed keys of a first secret key that is used to encrypt data registered in a database and is restorable with a predetermined number of distributed keys;
acquiring a key necessary for restoring the first secret key from a data management device that has determined to agree to permission of the use request for the data in intention expression on agreement or disagreement performed by each member of an organization that permits the use request for the data based on agreement of a plurality of members;
restoring the first secret key based on the distributed key and the key necessary for restoring the first secret key; and
outputting the restored first secret key to a user device used by a user who has made the use request for the data.
